(19) United States
(12) Patent Application Publication
(10) Pub. No.: US 2005/0105760 A1
(43) Pub. Date: May 19, 2005

(54) Data embedding and extraction

(76) Inventors: Joachim J Eggers, Erlangen (DE); Robert Baeuml, Heroldsberg (DE)

Correspondence Address: Philips Corporation;Intellectual Property Department, P O Box 3001, Briarcliff Manor, NY, 10510, US

(21) Appl. No.: 10/498,296

(22) PCT Filed: Nov. 20, 2002
(86) PCT No.: PCT/IB02/04898

(30) Foreign Application Priority Data
Dec. 14, 2001 (EP) 01204888.0

(51) Int. Cl. G06K 9/00

(52) U.S. Cl. 382/100

(57) ABSTRACT

Disclosed are a method and arrangement for embedding data (dn) in a host signal (xₙ) using dithered quantization index modulation (71), and extracting said data from the watermarked signal. A problem of this embedding scheme (71) is that the amplitude of the watermarked signal (sₙ) may have been scaled (72) unintentionally (by a communication channel) or intentionally (by a hacker). This causes the quantization step size (Δᵣ) of the received signal (rₙ) to be unknown to the extractor (73) which is essential for reliable data extraction. The invention provides making a histogram (74) of those signal samples that have substantially the same amount of dither, and analyzing said histogram to derive an estimation of the step size (Δᵣ) therefrom. In a preferred embodiment, a pilot sequence of predetermined data symbols (dₚᵢₗₒₜ) is embedded (76) in selected (S) samples of the host signal.

### FIELD OF THE INVENTION

The invention relates to a method and arrangement for extracting data from a host signal. The invention also relates to a method and arrangement for embedding data in a host signal, and to a signal with embedded data.

### BACKGROUND OF THE INVENTION

Blind watermarking is the art of embedding a message in a multimedia host signal, and decoding the message without access to the original, non-watermarked host signal. An example of such a watermarking scheme is disclosed in B. Chen and G. W. Wornell: “Quantization Index Modulation: A Class of Provably Good Methods for Digital Watermarking and Information Embedding”, published in IEEE Transactions on Information Theory, Vol. 47, No. 4, May 2001. The known watermarking scheme is a quantization-based watermarking scheme. The message is embedded in the host signal by quantization of the host signal, using a quantization step size which maps an input sample into an output sample which uniquely identifies a message symbol embedded in the output sample.

It has been shown in literature that blind watermarking withstands additive white Gaussian noise (AWGN) attacks as well as if the decoder had access to the original host signal. However, in practical watermarking applications, attacks are not constrained to AWGN attacks. A particularly interesting class of attacks is amplitude modification. This class of attacks includes scaling of the watermarked signal, e.g. contrast reduction for image data, or addition of a constant DC value. Unlike spread-spectrum watermarking schemes, which are typically believed to survive such attacks without significant losses, quantization-based watermarking schemes are vulnerable to amplitude modifications. This problem is particularly significant in quantization-based watermarking schemes that also use dithering. Dithering is the process of assigning different offsets to different samples of the watermarked signals so as to avoid that the embedded data can be detected by simply inspecting the structure of the watermarked signal. The series of dither values (“dither vector”) is a secret key which is known to the receiver. Without knowledge of the dither vector, it is impossible to extract the message in a reliable manner.

### OBJECT AND SUMMARY OF THE INVENTION

It is an object of the invention to provide a method and arrangement for extracting the data even if the amplitude of the watermarked signal has been modified.

In accordance with the invention, this is achieved by computing the quantizer step size of the received media signal from a histogram of selected signal samples having a predetermined range of dither values. The invention exploits the insight that, in case of an amplitude scaling attack, the quantizer step size used by the watermark embedding algorithm has been scaled by the same factor. It is achieved with the invention that the amplitude scaling factor can be calculated (or at least estimated) as the ratio of the step size computed by the decoder to the step size used by the embedder. This allows the received watermark signal to be re-scaled, and the embedded message to be extracted from the re-scaled signal by a conventional decoder. An embodiment of the decoder extracts the embedded message on the basis of the computed quantizer step size, even if the original quantizer step size (and thus the scaling factor) is unknown.

In a preferred embodiment, the selected signal samples are predetermined signal samples in which a predetermined data symbol has been embedded. This embodiment requires knowledge of the samples having the predetermined data symbol embedded therein. To this end, an embedder in accordance with the invention embeds said predetermined data symbol in predetermined samples of the host signal.

### BRIEF DESCRIPTION OF THE DRAWINGS

FIG. 1 shows a schematic diagram of a system comprising a data embedder, a channel and a data detector,

FIGS. 2 and 3 show diagrams to illustrate data embedding using the concept of dithered quantization index modulation,

FIGS. 4 and 5 show schematic diagrams of a data embedder and extractor, respectively,

FIGS. 6, 7A and 7B show diagrams to illustrate data extraction,

FIG. 8 shows a diagrams to illustrate data extraction in the system which is shown in FIG. 1,

FIG. 9 shows a diagram to illustrate the operation of an embodiment of the data extractor in accordance with the invention,

FIG. 10 shows a diagram to illustrate the operation of a further embodiment of the data extractor in accordance with the invention,

FIG. 11 shows a schematic diagram of a system comprising a data embedder and a data decoder in accordance with the invention,

FIG. 12 shows a schematic diagram of a system comprising a data embedder and a further embodiment of a data decoder in accordance with the invention,

FIG. 13 shows a diagram to illustrate the operation of an embodiment of a histogram analysis circuit which is shown in FIGS. 11 and 12.

### DESCRIPTION OF EMBODIMENTS

We consider digital watermarking as a communication problem. A watermark message is encoded into a sequence of watermark letters or symbols dₙ. The elements dₙ belong to a D-ary alphabet {0,1, . . . ,D-1} of size D. In many practical cases, binary watermark symbols (D=2) will be used.

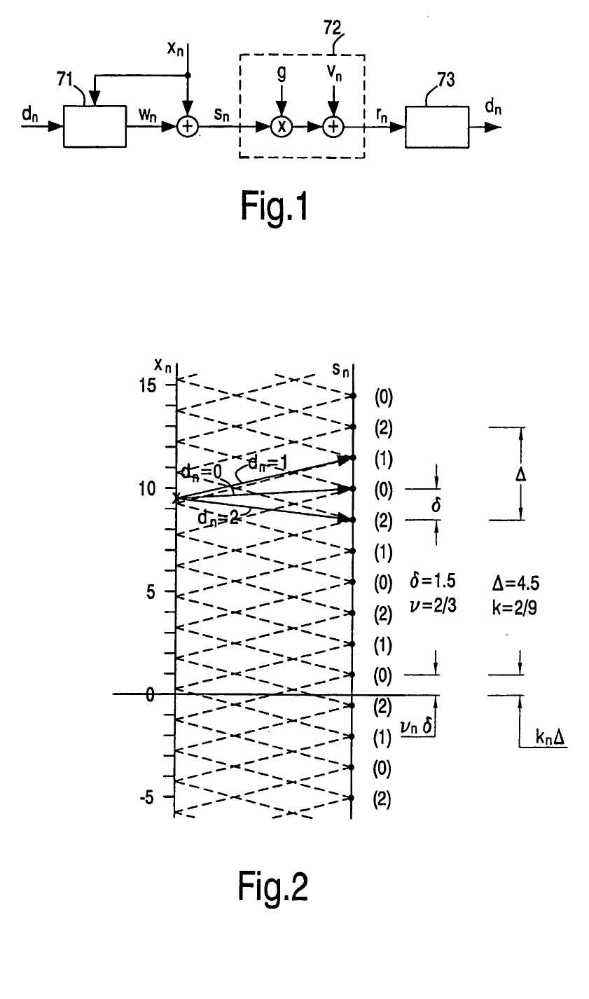

FIG. 1 shows a general schematic diagram of a system comprising a watermark embedder (or encoder) 71 and a detector (or decoder) 73. The watermark encoder derives from the encoded watermark message d and the host data x an appropriate watermark sequence w, which is added to the host data to produce the watermarked data s. The watermark w is chosen to be such that the distortion between x and s is negligible. The decoder 73 must be able to detect the watermark message from the received data r. FIG. 1 shows a “blind” watermarking scheme. This means that the host data x are not available to the decoder 73. The codebook used by the watermark encoder and decoder is randomized dependent on a secure key k to achieve secrecy of watermark communication. The signals x, w, s, r and k are vectors of identical length. The index n in FIG. 1 refers to their respective n^{th} elements (or samples).

In practice, the watermarked signal has undergone signal processing, passed through a communication channel, and/or it has been the subject of an attack. This is shown in FIG. 1 as an attack channel 72 between embedder 71 and detector 73. The attack scales the amplitude of the watermarked signal s with a factor g (usually g<1), and adds noise v. The channel may also introduce an additional offset r_{offset} in the attacked signal r. The receiver can compensate for scaling by dividing the attacked signal r by g to produce s+v/g. Accordingly, the design of watermark encoder 71 and detector 73 can be translated into the design of a system which needs to withstand noise only, provided that the scale factor g is known to the receiver.

In general, the watermark encoder 71 and decoder 72 involve a random codebook that is available at both ends. In the encoder 71, the codebook maps an input sample xₙ onto an output sample sₙ, the output sample value being dependent on the message symbol dₙ and the key kₙ. The decoder 73 uses the same codebook to reconstruct the message symbol dₙ from the sample sₙ. Sub-optimal but more practical versions of the system are based on dithered uniform scalar quantization as will be explained hereinafter.

In the simplest form of scalar quantization, message data is embedded in the media signal by quantizing the signal samples xₙ (all samples or selected ones) to a selected one of a number of sets of discrete levels, the selected set being determined by the data symbol to be embedded. This simplest form of watermark embedding is illustrated in FIG. 2 In this Figure, the left vertical axis represents a range of values that signal samples xₙ of a media signal x can assume. The message to be embedded in the media signal is encoded into a sequence of data elements dₙ belonging to a D-ary alphabet Dε{0,1, . . . D-1}. In FIG. 2, a ternary alphabet (D=3) is illustrated by way of general example. In practical systems, D=2 will often be used. The signal media samples xₙ, one of which is indicated by the symbol X on the left vertical axis in the Figure, is rounded to the nearest multiple of (Dm+dₙ)×δ, where δ is a given quantization step and m=. . . , −2,−1,0,1,2, . . . The quotient xₙ/δ, known as quantization index, is modulated with the data to be embedded. Low-bit modulation, a well-known data embedding technique, is a special case. Low-bit modulators simply replace the least significant bit of digital signal samples xₙ by a data bit dₙ.

The data accommodated in the watermarked signal can easily be detected by inspecting the discrete signal values sₙ. In low-bit modulation schemes, it even suffices to inspect the least significant bit of sₙ. If it is 0, then dₙ=0. If it is ‘1’, then dₙ=1. In order to provide secure transmission of the message, different offsets are assigned to different output signal samples sₙ. This is referred to as dithering. In FIG. 2, the offset is denoted vₙδ, where vₙ is a multiplication factor. The set of dither values vₙ used to embed data in the sequence of signal samples xₙ constitutes a secure dither vector, also referred to hereinafter as secret key. Without knowledge of this key, no structure is visible in the samples sₙ, and it is not possible to detect the data message.

A mathematical expression of the dithered uniform scalar quantization embedding process can be derived as follows. The output signal sₙ can be written as:
sₙ=(Dm+dₙ)×δ+vₙδ (1)
The value sₙ must be as close as possible to the input value xₙ, which can be expressed as:

$$\begin{matrix}{x}_{n} ≅ {s}_{n} \\ {x}_{n} ≅ ( Dm + {d}_{n} ) \times δ + {v}_{n} δ \\ m ≅ \frac{{x}_{n} - ( {d}_{n} + {v}_{n} ) \times δ}{D δ}\end{matrix}$$

This condition is fulfilled if

$$m = round \{ \frac{{x}_{n} - ( {d}_{n} + {v}_{n} ) \times δ}{D δ} \} \qquad ( 2 )$$

Substitution of (2) in (1) yields:

$${s}_{n} = D δ \times round \{ \frac{{x}_{n} - ( {d}_{n} + {v}_{n} ) \times δ}{D δ} \} + ( {d}_{n} + {v}_{n} ) \times δ \qquad ( 3 )$$

An alternative expression can be obtained by introducing Δ=Dδ and

$${k}_{n} = \frac{{v}_{n}}{D} ,$$

and denoting the operation

$$Δ \times round \{ \frac{•}{Δ} \}$$

by an operator Q_{Δ}{●} to. The latter operator denotes conventional scalar uniform quantization with step size Δ, hence the name of this practical embedding scheme. The data embedding process can now be expressed as:

$${s}_{n} = {Q}_{Δ} \{ {x}_{n} - Δ ( \frac{{d}_{n}}{D} + {k}_{n} ) \} + Δ ( \frac{{d}_{n}}{D} + {k}_{n} ) \qquad ( 4 )$$

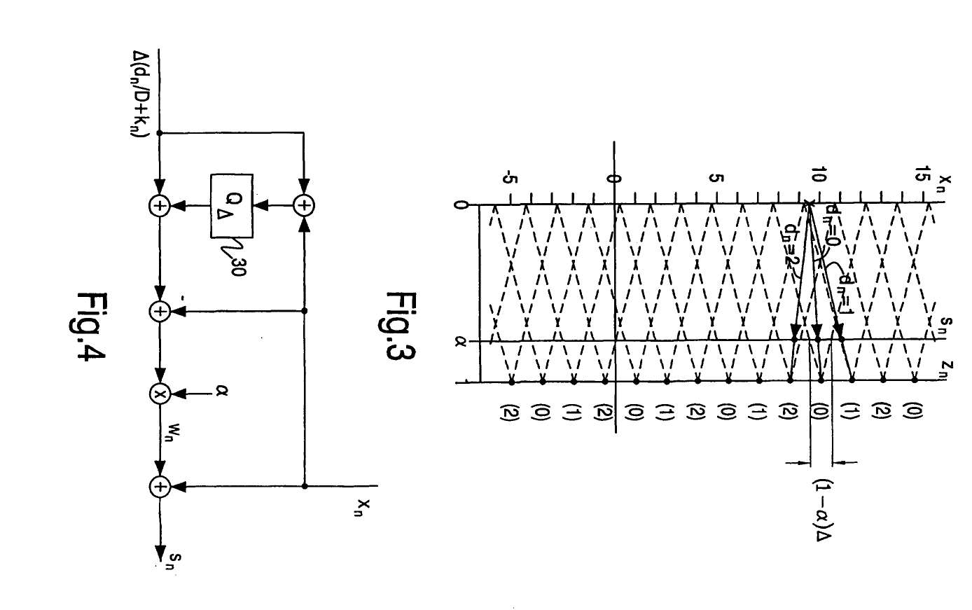

The data embedding process can even be more generalized. It is not necessary to project xₙ on discrete points of the sₙ-axis. The data symbols dₙ may equally be represented by distinct ranges of values sₙ, as has been shown in FIG. 3. It can easily be derived from this Figure that the output signal sₙ can now be described as:
sₙ=xₙ+α(zₙ−xₙ)
where zₙ denotes the discrete points as defined above by equation (4). Accordingly,

$${s}_{n} = {x}_{n} + α \times ( {Q}_{Δ} \{ {x}_{n} - Δ ( \frac{{d}_{n}}{D} + {k}_{n} ) \} + ( \frac{{d}_{n}}{D} + {k}_{n} ) - {x}_{n} ) \qquad ( 5 )$$

FIG. 4 shows a schematic diagram of the embedder 71 in accordance with equation (5). Herein, reference numeral 30 denotes a scalar uniform quantizer with step size Δ=Dδ.

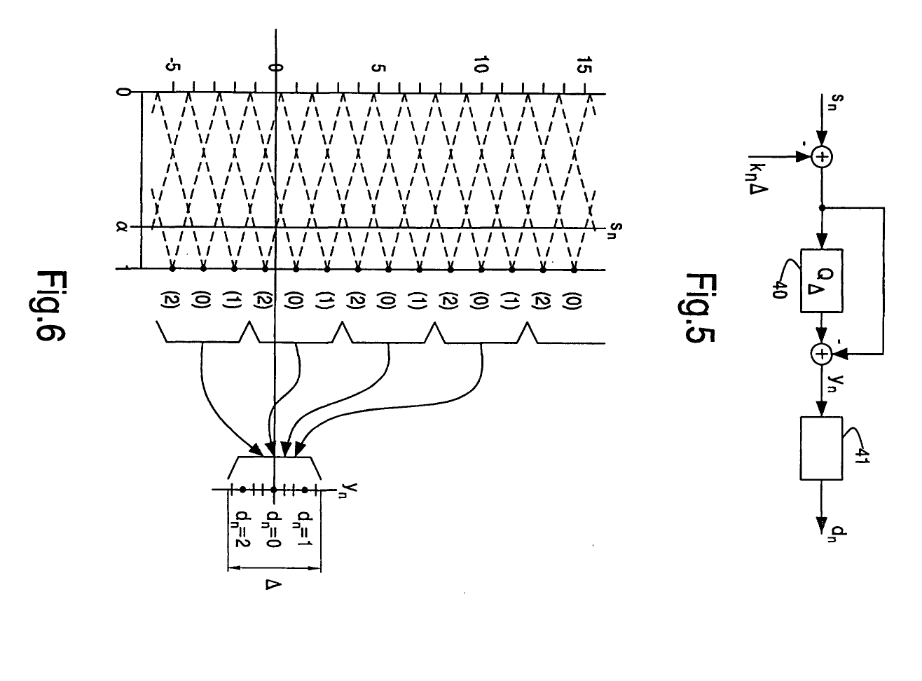

FIG. 5 shows a schematic diagram of the detector 73 for extracting the data message bits dₙ from the signal samples sₙ. In this Figure, reference numeral 40 denotes the same scalar uniform quantizer with step size Δ as quantizer 30 in FIG. 4. The detector generates an intermediate signal yₙ in accordance with the following mathematical operation:
yₙ=Q_{Δ}{sₙ−kₙΔ}−(sₙ−kₙΔ) (6)
As illustrated in FIG. 6, this operation causes the samples sₙ to be shifted to a range

$$- \frac{Δ}{2} < {y}_{n} < + \frac{Δ}{2}$$

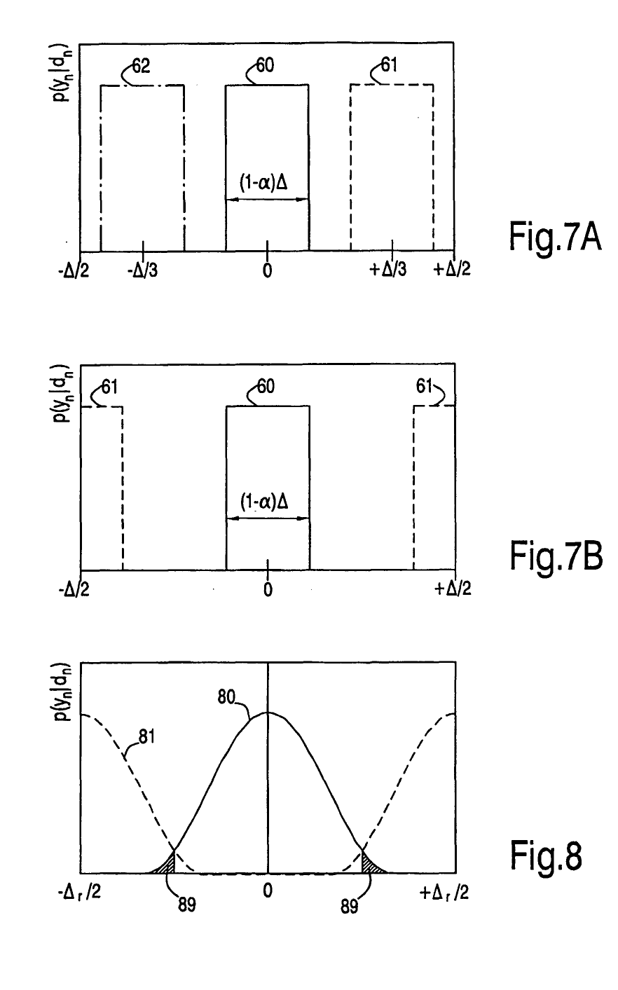

FIG. 7A shows the probability density function (PDF) of the intermediate signal samples yₙ conditioned on the transmitted symbol dₙ for D=3. More particularly, a solid line 60 denotes the PDF p(yₙ|dₙ=0) of the watermarked elements conditioned on the watermarked symbol dₙ=0, a dashed line 61 denotes p(yₙ|dₙ=1), and a dot- and dash-line 62 shows p(yₙ|dₙ=2). For comparison and completeness, FIG. 7B shows the PDF of yₙ for D=2, which is more likely to be used in practical systems. Herein, numerals 60 and 61 denote the PDFs for dₙ=0 and dₙ=1, respectively.

FIGS. 7A and 7B show that the data symbol dₙ can easily be reconstructed from yₙ by an appropriate slicing and decoding circuit. The latter circuit is denoted 41 in FIG. 5. For D=3, this circuit checks whether yₙ is sufficiently close to 0, +Δ/3 or −Δ/3 (cf. FIG. 7A). For D=2, it checks whether yₙ is sufficiently close to 0 or ±Δ/2 (cf. FIG. 7B).

It should be noted that the schematic diagrams of the embedder and detector shown in FIGS. 4 and 5 are physical implementations of the mathematical equations (5) and (6), respectively. Other practical embodiments are possible. For example, the detector may be designed to implement the following equation:

$$d = mod ( round \{ \frac{{s}_{n} - {v}_{n} δ}{δ} \} , D ) \qquad ( 7 )$$

Equation (7) can be understood if it is considered that

$$m = round \{ \frac{{s}_{n} - {v}_{n} δ}{δ} \}$$

is the number of times step size δ fits into sₙ−vₙδ (see FIG. 1), and dₙ=mod(m,D).

In any case, reliable detection requires that besides the secure key kₙ (or vₙ) also the step size Δ (or δ) is known. However, as has been shown in FIG. 1, an attack 72 may have been applied to the watermarked signal. FIG. 8 shows the PDF of the detector's intermediate signal yₙ (see Eq. 7) for D=2 in the case of an attack with additive white Gaussian noise (AWGN) v and scaling factor g. In a similar manner as in FIG. 7B, a solid line 80 denotes the PDF p(yₙ|dₙ=0) conditioned on the watermarked symbol dₙ=0, and a dashed line 81 denotes p(yₙ|dₙ=1) conditioned on the watermarked symbol dₙ=1. The hatched areas 89 represent the error probability (detection of dₙ=1 where dₙ=0 was embedded). The embedder system's parameters α and Δ have been chosen to be such that a desired error probability is achieved for a given noise variance σᵥ² of the noise v. The inventors have found that a good approximation is given by:

$${Δ}_{opt} = \sqrt{12 ( {σ}_{w}^{2} + 2.71 {σ}_{v}^{2} )} and {α}_{opt} = \sqrt{\frac{{σ}_{w}^{2}}{{σ}_{w}^{2} + 2.71 {σ}_{v}^{2}}}$$

where σ_{w}² represents the embedding distortion.

It should be recalled that generation of the intermediate signal yₙ requires knowledge of the quantizer step size and the secure key kₙ. The quantizer step size of the attacked signal r, which is now Δᵣ=gΔ due to the scaling by the factor g, has to be estimated from the received data r. Note that estimation of Δᵣ is equivalent to estimation of g when Δ is known. Here, the more general point of view is taken, and estimation of Δᵣ is considered.

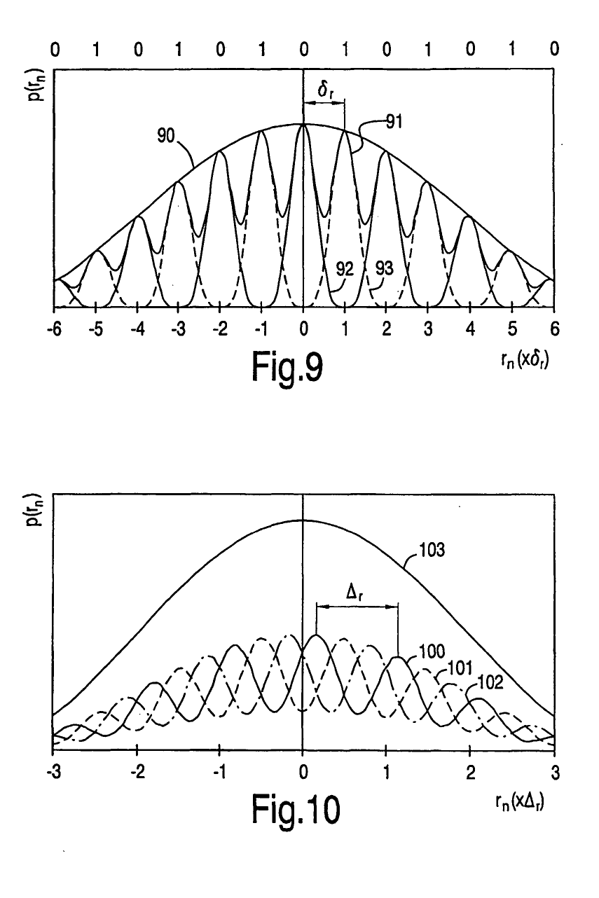

An estimation of Δᵣ (and an estimation of the offset r_{offset}, if any), can be obtained by analyzing a histogram of received samples rₙ. However, as mentioned before, dithering has been applied to avoid that the embedded data can be easily detected by simply inspecting the signal samples. Because of the dithering, there is no structure in the received samples. The histogram of received samples is more or less a continuous graph in practice. FIG. 9 shows such a histogram 90 by way of example.

Recall that dithering has been created by assigning offsets kₙΔ (or vₙδ) to the samples sₙ. Due to the scaling by the factor g, the offsets of the received samples rₙ are kₙΔᵣ, (or vₙδᵣ). These offsets are unknown at the receiver end because g is unknown. The key kₙ, however, is known. Therefore, in accordance with one aspect of the invention, the histogram is derived from only those samples that have a given predetermined key value kₙ assigned thereto. Reference numeral 91 in FIG. 9 is an example of a histogram of samples for which kₙ=0. The relative distance between the local maxima of the histogram is the step size δᵣ=Δᵣ/D. The Figure also illustrates the individual histograms 92 and 93 of samples with embedded data symbols d=0 and d=1, respectively, that collectively constitute the histogram (D=2 is assumed here; the data symbols d associated with the signal samples r are shown at the top of FIG. 9). The “pulse width” of the histogram depends on the embedder's parameter α (which spreads an input value over a range of output values) and the noise variance σᵥ² of the attack channel.

Creating a statistically reliable histogram from only those samples that have a given predetermined key kₙ assigned thereto requires a large number of samples having that key to be collected. This may take a too long time. This disadvantage is mitigated in an embodiment in which one or more histograms are created for signal samples with keys k, in a range:

$$\frac{m}{M} \leq {k}_{n} < \frac{m + 1}{M} , for m ∈ \{ 0 , 1 , … , M - 1 \} and M > 1. \qquad ( 8 )$$

The histograms (or histograms) thus obtained will show wider peaks with the relative distance δᵣ. Moreover, the peaks are shifted to the right because the offset ranges are positive.

In a further embodiment, the histogram is created from samples rₙ having a predetermined data symbol dₙ embedded therein. Such an embodiment has the advantage that the peaks will have a larger relative distance Δᵣ (D times the distance δᵣ of the previous embodiment), and larger maximum-to-minimum ratios. This embodiment allows the step size Δᵣ to be calculated more accurately. In order to render it possible that the receiver can select samples having the predetermined data symbol, the embedder is arranged to embed a “pilot” sequence of said data symbols in the signal. The predetermined pilot symbol, further referred to as dₚᵢₗₒₜ, is one of the available data symbols {0,1, . . . D-1}, for example dₚᵢₗₒₜ=0. The pilot sequence is dithered like the normal signal samples and thus securely embedded. Without knowing the secure key k, no structure in the watermarked signal is visible.

The pilot sequence can be. accommodated in the signal, inter alia, by embedding a pilot symbol dₚᵢₗₒₜ in every k^{th} sample of the input signal, or by (preferably repeatedly) inserting a fixed-length series of pilot symbols in the embedded message. Relevant to the invention is only that the receiver knows which samples r, have an embedded pilot symbol. As far as histogram analysis is concerned, only the samples rₙhaving the embedded pilot symbol will be considered hereinafter.

Again, the histogram is generated from those samples having a given predetermined key value kₙ (for example, kₙ=0) or a predetermined range of key values as defined by equation (8). FIG. 10 shows a histogram 100 of the pilot sequence for D=2, dₚᵢₗₒₜ=0, and range index m=0 (i.e. 0≦kₙ<0.33). The peaks now have a relative distance Δᵣ. Note that the local maxima are shifted to the right compared with histogram 91 in FIG. 9, because a range of positive offsets kₙΔᵣ has been taken into consideration. A possibly different shift must necessarily have been introduced by the attack channel in the form of an offset r_{offset}. Said offset can thus be computed from the histogram 100 too.

The histogram 100 is derived from one third of the pilot samples (M=3). Similar histograms can be derived for m=1 (0.33≦kₙ<0.67) and m=2 (0.67≦kₙ<1), so that all samples of the pilot sequence are taken into account for the histogram analysis. They are denoted 101 and 102 in FIG. 10. Note that the sum of the histograms 100, 101, and 102 is the histogram of all samples of the pilot sequence, irrespective of their key value kₙ. This total histogram is denoted 103 in FIG. 10.

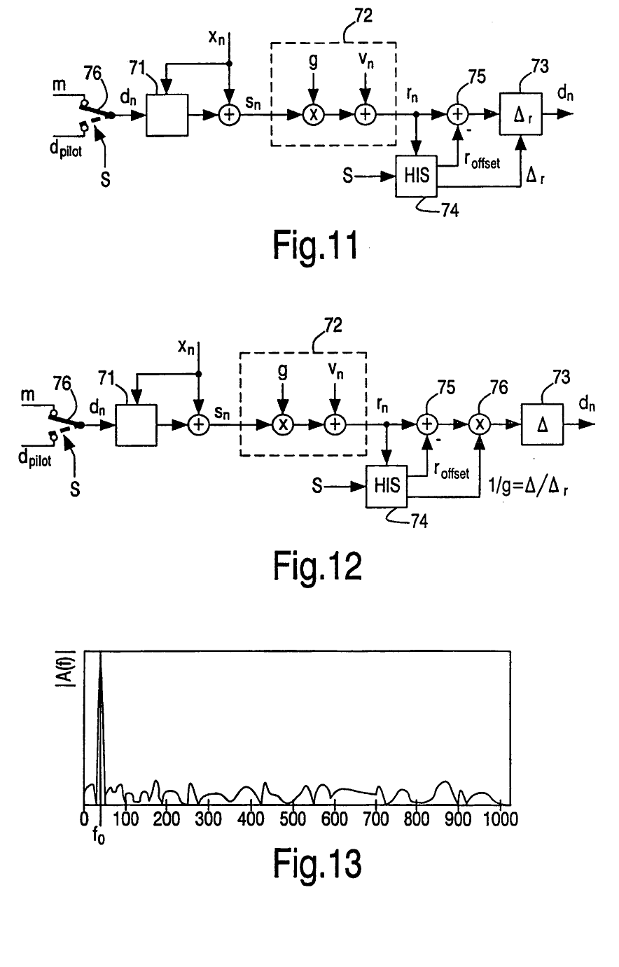

FIG. 11 shows a diagram of a system comprising an embedder and a receiver in accordance with the embodiments described above. Identical reference numerals are used to denote the same elements and functions as in FIG. 1. The receiver now includes a histogram analysis circuit 74 which receives the signal samples rₙ and computes the offset r_{offset}, if any, and the step size Δᵣ. The offset r_{offset} is the same for all samples and is subtracted therefrom by a subtractor 75. The computed step size Δᵣ is directly applied to the detector 73 which reconstructs the embedded data symbols dₙ in accordance with equations (6) and (7) and FIG. 5. The symbol Δᵣ in detector 73 denotes that the step size Δ in equations (6) and (7) and FIG. 5 is to be replaced Δᵣ.

In case a pilot sequence is used, a selection signal S is applied to the histogram analysis circuit to identify the signal samples rₙ having the embedded pilot symbols dₚᵢₗₒₜ. At the transmitting end, a switch 76 being controlled by the same selection signal S is used to apply either a message symbol m or a pilot symbol dₚᵢₗₒₜ to the embedder 71.

The system shown in FIG. 12 includes a further embodiment of the receiver. In this embodiment, the watermarked signal is re-scaled, in a multiplication stage 76, by multiplication with g⁻¹=Δ/Δᵣwhere Δ is the step size being employed by detector 73. The advantage of this embodiment is that the same detector 73 can be used for all amplitude scaling factors g. The step size A is not necessarily the original step size used by the embedder.

A practical embodiment of the histogram analysis circuit will now be described for application in the embodiment using a pilot sequence. It can be implemented in hardware or software. First, the whole range of sample values rₘᵢₙ≦rₙ≦rₘₐₓ is divided into L_{bin} bins. For each bin, the histograms p_{r,m}(b) are computed, where bε{0,1,.. .,L_{bin}-1} is the bin index, and mε{0,1, . . . ,M-1} indicates the considered range of key values kₙ. For M=3, this will yield 3 “conditional” histograms per bin that resemble the histograms 100, 101, and 102 shown in FIG. 10. For each bin, the “total” histogram pᵣ(b) (cf. 103 in FIG. 10) is computed too. Empty bins and bins that contain only a few samples are assigned a uniform non-zero histogram. The conditional histograms p_{r,m}(b) are subsequently normalized, and the discrete Fourier spectrum Aₘ(f) of each normalized histogram is computed is computed in accordance with:

$${A}_{m} ( f ) = DFT \{ \frac{{p}_{r , m} ( b )}{{p}_{r} ( b )} - 1 \}$$

For Gaussian distributed rₙ, but also for other typical signal distributions, empty and almost empty bins occur mainly at the tails of the histograms. Therefore, it is useful to also weight the normalized histograms with a window function W(b) that gives a different weight to the tails. In that case, the Fourier spectra are computed in accordance with:

$${A}_{m} ( f ) = DFT \{ \frac{{p}_{r , m} ( b ) - {p}_{r} ( b )}{{p}_{r} ( b )} W ( b ) \}$$

All M spectra can be combined in an elegant way since it is known that the maxima in the different conditional histograms are shifted against each other by Δᵣ/M. This shift corresponds to a multiplication by

$${ⅇ}^{- j \frac{2 π}{M} m}$$

in the Fourier domain so that the overall spectrum can be obtained as:

$$A ( f ) = {\sum }_{m = 0}^{M - 1} {A}_{m} ( f ) {ⅇ}^{- j \frac{2 π}{M} m}$$

FIG. 13 shows an example of the modulus |A(f)| of the spectrum using a 1024-length discrete Fourier transform. A dominating peak at f₀ is clearly visible. The step size Δᵣ follows from:

$${Δ}_{r} = \frac{{L}_{DFT}}{{f}_{0}} \frac{{r}_{max} - {r}_{min}}{{L}_{bin}}$$

where L_{DFT} is the length of the discrete Fourier transform. The offset r_{offset} can be derived from the argument arg{A(f₀)} of the complex Fourier spectrurn.

Disclosed are a method and arrangement for embedding data (dₙ) in a host signal (xₙ) using dithered quantization index modulation (71), and extracting said data from the watermarked signal. A problem of this embedding scheme (71) is that the amplitude of the watermarked signal (sₙ) may have been scaled (72) unintentionally (by a communication channel) or intentionally (by a hacker). This causes the quantization step size (Δᵣ) of the received signal (rₙ) to be unknown to the extractor (73) which is essential for reliable data extraction. The invention provides making a histogram (74) of those signal samples that have substantially the same amount of dither, and analyzing said histogram to derive an estimation of the step size (Δᵣ) therefrom. In a preferred embodiment, a pilot sequence of predetermined data symbols (dₚᵢₗₒₜ) is embedded (76) in selected (S) samples of the host signal.

1. A method of extracting data symbols (dₙ) from a media signal (rₙ), the data symbols being embedded in said media signal by quantization of a host signal (xₙ) using a quantization step size (δ), and dithering of the quantized signal (sₙ) in accordance with a dither vector (kₙ), characterized in that the method comprises the steps of estimating the quantizer step size (δᵣ) of the received media signal (rₙ) from a histogram of selected signal samples having a predetermined range of dither values, and using said estimated step size to extract the data symbols from the media signal.

2. A method as claimed in claim 1, wherein said range of dither values is a predetermined fraction of the range of applicable dither values.

3. A method as claimed in claim 1, wherein the selected signal samples (rₙ) are predetermined signal samples in which a predetermined data symbol (dₚᵢₗₒₜ) has been embedded.

4. A method as claimed in claim 1, wherein the quantizer step size is computed using a Fourier transform of the histogram.

5. A method of embedding data symbols in a host signal by quantizing said host signal (xₙ) using a quantization step size (δ), and dithering the quantized signal in accordance with a dither vector (kₙ), characterized in that the method includes embedding a predetermined data symbol (dₚᵢₗₒₜ) in predetermined samples of the host signal.

6. An arrangement for extracting data symbols (dₙ) from a media signal (rₙ), the data symbols being embedded in said media signal by quantization of a host signal (xₙ) using a quantization step size (δ), modulation of the quantization index with the data symbols, and dithering of the quantized signal in accordance with a dither vector (kₙ), characterized in that the arrangement includes means (74) for making a histogram of selected signal samples having a predetermined range of dither values, and computing the quantizer step size (δᵣ) of the received media signal (rₙ) from said histogram.

7. An arrangement as claimed in claim 1, wherein the selected signal samples (rₙ) are predetermined signal samples in which a predetermined data symbol (dₚᵢₗₒₜ) has been embedded.

8. An arrangement for embedding data symbols in a host signal by quantizing said host signal (xₙ) using a quantization step size (δ), modulating the quantization index with the data symbols, and dithering the quantized signal in accordance with a dither vector (kₙ), characterized in that the arrangement includes means (76) for embedding a predetermined data symbol (dₚᵢₗₒₜ) in predetermined samples of the host signal.

9. A signal (sₙ) with embedded data symbols, comprising signal samples obtained by quantization of a host signal (xₙ) using a quantization step size (δ), modulation of the quantization index with the data symbols, and dithering of the quantized signal in accordance with a dither vector (kₙ), characterized in that the signal includes embedded predetermined data symbols (dₚᵢₗₒₜ) in predetermined samples of the host signal.
